(19) United States
(12) Patent Application Publication
(10) Pub. No.: US 2026/0274566 A1
(43) Pub. Date: Sep. 17, 2026

(54) CHANGING AREA FOR SPA POOLS, INDOOR POOLS, OUTDOOR POOLS AND FITNESS STUDIOS

(71) Applicant: Delta-X GmbH Ingenieurgesellschaft, Stuttgart (DE)

(72) Inventors: Albrecht Burmeister, Weissach im Tal (DE); Walter Klas, Neukirch (DE)

(21) Appl. No.: 19/469,107

(22) PCT Filed: Feb. 26, 2024
(86) PCT No.: PCT/EP2024/054827

§ 371 Date: Sep. 25, 2025

(30) Foreign Application Priority Data
Apr. 3, 2023 (DE) 10 2023 108 461.5

(51) Int. Cl. B65G 1/04; B25J 5/00; E04H 3/16; G05D 1/244; G05D 107/70

(52) U.S. Cl. CPC B65G 1/0435; B25J 5/00; B65G 1/0421; E04H 3/16; G05D 1/244; G05D 2107/70

(57) ABSTRACT

A changing area is provided that includes a plurality of changing cubicles arranged in a row, each cubicle having walls with an opening that exposes a storage location for a storage box. A shelf storage is positioned directly behind the cubicles, the shelf storage including multiple storage locations arranged side by side and one above another. The storage locations assigned to the cubicles are integrated into the shelf storage. A manipulator with an effector, configured as an articulated arm robot, is located behind the shelf storage. The effector of the manipulator is capable of accessing all storage locations of the shelf storage, including the storage locations assigned to the cubicles.

### DESCRIPTION

The invention relates to the changing areas of spas, public swimming pools (outdoor or indoor pools), fitness studios, but also to the changing areas of industrial plants where workers change their clothes before starting work, exchanging their everyday clothes for their work clothes.

For many decades, a system has been established in such changing areas that is very static, offers little convenience and requires a lot of space: There are changing cubicles in which the user changes. The user takes off his everyday clothes and puts on, for example, swimming trunks, a swimsuit, sportswear or workwear. The stored everyday clothes are hung on a hanger and locked in a locker. The locker is not located in the changing cubicle, but at another location. The user takes the key to this locker along with them.

When the user wants to leave the spa or the workplace, he first goes to the locker and takes the hanger out of it with the clothes hanging on it. With the hanger in his hand, he goes into a free changing cubicle and changes there. This system is not very user-friendly, because the user has to go to two places every time he want to change: the changing cubicle and the place where the lockers are located.

In large changing areas, this leads to many users moving around in the corridors and hallways between the changing cubicles and lockers. This “pedestrian traffic” requires wide aisles and corridors. That is, the space requirement is considerable. However, it also increases the number of contacts between users. These contacts are undesirable because they contribute to the transmission of infections, whether it be colds, flu, or the coronavirus.

From JP H07 107718B2 , a changing area with a plurality of changing cubicles is known, which includes a plurality of changing cubicles. “Behind” an exterior wall of the changing cubicles is a high-shelf storage with a plurality of storage locations for storage boxes. An intermediate area is provided between the high-shelf storage and the changing cubicles.

A storage box is transported from a changing cubicle to a free storage location in the high-shelf storage via a conveyor belt in the intermediate area and a stacker crane in the high-shelf storage. The transport of a storage box between a storage location in the high-shelf storage and a changing cubicle requires the use of the stacker crane and a conveyor belt. The system known from JP H07 107718 B2 requires a lot of space. Furthermore, it is very complex and comparatively expensive to manufacture and operate.

The invention is based on the object of providing a changing area that is more user-friendly and attractive, that causes less pedestrian traffic in the aisles and hallways of the changing area and also requires less space in relation to the number of users. Finally, it should also be more cost-effective compared to the state of the art.

With a changing area, comprising a plurality of changing cubicles, wherein each changing cubicle comprises a plurality of walls and a door, wherein a wall of the changing cubicle has an opening which exposes a storage location for a storing box, wherein a plurality of changing cubicles is arranged in a row next to one another, wherein a shelf store for storing boxes is arranged behind the walls with opening of the changing cubicles, this object is achieved in that the shelf storage is arranged directly behind the walls with opening of the changing cubicles, in that the storage locations assigned to the changing cubicles are integrated into the shelf storage, a manipulator with an effector is provided (behind) the shelf storage, and all storage locations of the shelf storage, including intermediate storage locations, can be reached by the effector of the manipulator.

The changing cubicle according to the invention, like other changing cubicles, usually has four walls. One of the walls has a door through which the user can enter the inside of the changing cubicle. There is an opening in one wall of the changing cubicle. This is usually the wall opposite the door.

The walls of the changing cubicle, which the user in the changing cubicle sees, are referred to in the context of the invention as “inner walls” of the changing cubicle. The rear side or outside of these walls are therefore referred to as the outside of a wall of a changing cubicle.

The manipulator located behind the shelf storage(s) seen from a changing cubicle can reach the storage locations of all shelf storages. Therefore, only one manipulator is required to place the transport boxes in the storage locations and intermediate storage locations or to remove a transport box from one of the storage locations or intermediate storage locations. This saves considerable space and costs.

If the changing cubicles are arranged in two rows, then usually two shelf storages are arranged along these two rows. They are arranged directly on the outer walls of the changing cubicles. To increase the number of storage locations, storage racks can also be arranged at both ends of the aisle. The manipulator can also reach the storage locations LP of these “additional” storage racks and place storage boxes in them or remove said boxes from them.

The opening in the wall of the changing cubicles is dimensioned and positioned such that it provides access from inside the changing cubicle to a storage location in the shelf storages located behind the changing cubicle.

This storage location is also called an intermediate storage location.

In other words: Through the opening, a user who is in the changing cubicle has access to a storage box that is located in the (intermediate) storage location of the shelf storage behind the opening. The user can fill the storage box in the opening with his clothes or other items. At a later time, he can remove the clothes or items from the storage box that is located in the storage location of the shelf storage behind the opening.

After the user has changed, this storage box is removed from this storage location by the manipulator and is stored in another storage location in this shelf storage or the shelf storage on the outside of another changing cubicle. This frees up the storage location behind the opening.

The users in the changing cubicle do not have access to the storage boxes stored in the other storage locations. From inside the changing cubicle, users can only reach one storage box which is located in the storage location behind the opening in the wall of “his” changing cubicle.

The arrangement according to the invention makes it possible that shortly after a user has selected a changing cubicle, for example by opening the door and entering it, a storage box assigned to this user is removed from its storage location in the shelf storage and brought to the storage location of the shelf storage that is located behind the opening in the changing cubicle selected by the user.

If the user is still wearing his everyday clothes, the storage box assigned to him is then empty, and he can fill it with his clothes and other items that he does not want to take with him into the sauna or wellness area.

As soon as the user leaves the changing cubicle or indicates by another signal that the changing process is complete, the storage box assigned to the user is removed by the manipulator from the storage location located behind the opening and stored in another storage location that is not accessible from inside a changing cubicle and through the opening in the wall of this changing cubicle.

This means the changing cubicle is again available for another user. At the latest when this other user enters the changing cubicle, the storage box assigned to him is brought to the storage location located behind the opening with the help of the manipulator so that the other user can change.

At the end of the visit to the spa, the user enters any free changing cubicle. The manipulator retrieves the storage box assigned to the user from its storage location and places it in the (temporary) storage location that is located behind the opening of the changing cubicle in which the user is located. There, the user can take out his everyday clothes from the assigned storage box and change. After the user has changed, the storage box is empty; the assignment to the user can be canceled, and the storage box can be used by a new visitor.

The changing area according to the invention allows each user to always have access to the (“his”) storage box assigned to him when he is in a changing cubicle of his choice. He does not have to subsequently lock the storage box in a locker that is located at some distance from the changing cubicle. This is done by the manipulator. This significantly increases the convenience for users because “unnecessary” paths between the changing cubicle and locker or between the locker and changing cubicle are eliminated. This avoids a lot of foot traffic in the changing area. As a result, the traffic areas for users can also be made correspondingly smaller.

Another benefit in terms of convenience and user-friendliness that should not be underestimated is the fact that the user does not have to remember where or in which locker he has stored his items and everyday clothes.

The user is free in his choice of changing cubicle; “his” storage box is automatically stored temporarily in a free storage location in a shelf storage system on the outside of an arbitrary changing cubicle. If the user goes to a different changing cubicle after visiting the wellness or sauna area, the storage box assigned to him will be taken by the manipulator to the storage location behind the opening in his cubicle immediately after he enters the cubicle. The user can change clothes and while doing so has access to the items in “his” storage box.

Another advantage of this design is that it makes it easier to clean the changing cubicle and storage boxes. It is possible to automatically clean and/or disinfect the storage boxes when they are empty. This effectively prevents the spread of germs or viruses via the storage boxes.

Since there are no locker areas accessible to the public, not only is space/traffic area saved, but the cleaning and maintenance of these traffic areas is also eliminated.

In addition, there are a variety of possible functionalities that result from the individual assignment between a user and a storage box. For example, whenever a user wants to leave the changing area or the wellness or sauna area and/or the facility (spa), it can automatically be checked whether the storage box assigned to the user is empty.

If there is still an item in the storage box, the user can be informed of this when leaving the facility, and the item can be handed over to him. This is another major benefit and gain in convenience for the user of the changing area according to the invention.

In a preferred embodiment, the shelf storage is arranged in the manner of a grid, with “m” storage locations arranged next to one another and “n” storage locations arranged one above the other. For example, if five (5) storage locations are arranged next to one another and four (4) storage locations are arranged one above the other, then the shelf system has a total of 20 storage locations. One of these storage locations is assigned to the opening in the wall of the changing cubicle, leaving 19 storage locations that cannot be accessed by users of the changing area. These storage locations can be used as theft-proof temporary storage for storage boxes.

Many commercially available manipulators can be used as the manipulator. In automation technology, a device is called a manipulator (English: handling device or handling equipment) that manages the flow of materials to and from a site of action, i.e., is used for handling (source: Wikipedia “Manipulator”).

The widely known industrial robots or articulated arm robots are manipulators within the meaning of the invention. When handling, a defined position of a geometrically defined object (here the placement of a storage box in a storage location of a shelf storage) is either created or maintained for a limited time. The manipulators used in the invention are usually program-controlled. They are very well suited for handling the storage boxes in a changing area according to the invention.

According to the invention, a plurality of changing cubicles can be arranged in two spaced-apart rows so that an aisle is created between the two rows. The shelf storage and at least one manipulator (stationary or mobile) are arranged in the aisle so that the manipulator can reach all storage locations of both rows of changing cubicles. This results in an attractive, user-friendly and space-saving arrangement of the changing cubicles, while providing a sufficient number of storage locations in the shelf storages on the outside of the changing cubicles.

The capacity of the changing area according to the invention can be scaled by the number of changing cubicles in a row. Of course, a plurality of changing areas (each with two rows of changing cubicles) can be arranged next to one another or distributed over a plurality of floors one above the other.

In an advantageous embodiment, at least one of the manipulators present in the aisles is movable. This means that almost any number of changing cubicles can be arranged in a row. By moving the manipulator in the aisle, it can reach all storage locations in the changing area despite its limited range.

In order to ensure scalability of the changing area according to the invention, two or three changing areas according to one of the preceding claims can be set up next to one another on the same level and linked to one another via one, two, or three radial transport apparatuses in such a way that the storage boxes can be transported back and forth between the changing areas.

This principle can also be scaled in a vertical direction by arranging a plurality of changing areas one above the other. In this case, one, or preferably several, vertical conveyor devices are additionally provided, which connect the radial transport apparatuses on different levels with one another. Storage boxes can then be transported vertically back and forth between different levels.

In order to enable the exchange of storage boxes between the manipulators arranged in different changing areas, a horizontal conveyor device can be arranged above the changing areas, wherein the horizontal conveyor device can accept a storage box from a first manipulator and deliver it to another manipulator which is located in a different aisle than the first manipulator. The horizontal conveyor device is preferably movable on a closed track or a rail and can accept a storage box from a second storage from a manipulator and deliver this storage box to the manipulator of another changing area.

A plurality of changing areas can also be arranged on two or more levels above one another. Then, at least one vertical conveyor device is provided which connects the radial transport apparatus(es) and/or the horizontal conveyor device(s) of different levels to one another so that storage boxes can be transported back and forth between the different levels.

If the changing cubicles are arranged in a circle, the manipulator is preferably located in the center of this circle. Then there is no aisle in the true sense. The manipulator does not have to be movable, but can be installed in a fixed location. By swiveling and rotating the manipulator, it can reach all storage locations and fill them with storage boxes or remove a storage box from them.

The horizontal conveyor device arranged above the manipulators not only bridges the changing cubicles, but also the access routes along which users walk into the changing cubicles. This makes it possible to exchange storage boxes between the shelf storages of different changing areas without disturbing the users of the changing areas according to the invention.

Thanks to the horizontal conveyor device, every storage location in every shelf storage can be used as intermediate storage for a storage box. The transport or exchange of storage boxes between the shelf storages in the aisles of different changing areas is always ensured.

Further advantages and advantageous embodiments of the invention can be seen in the following drawing, its description and the claims. All the features disclosed in the drawings and the description can be essential to the invention both individually and in any combination.

In the drawings:

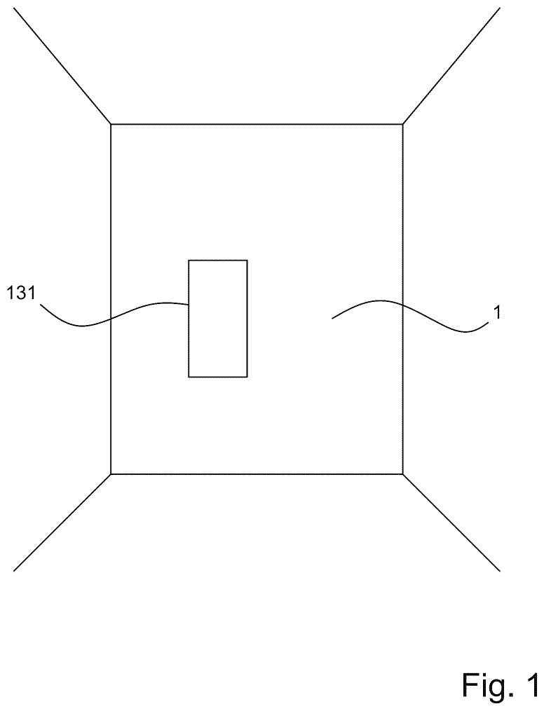

FIG. 1 shows a view of the inside of a changing cubicle according to the invention;

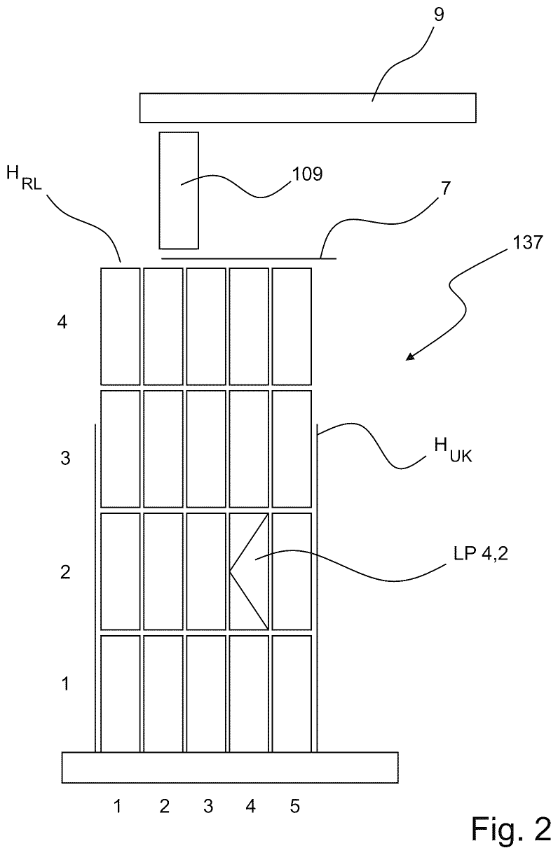

FIG. 2 shows a view of an exterior wall with a shelf storage arranged in front;

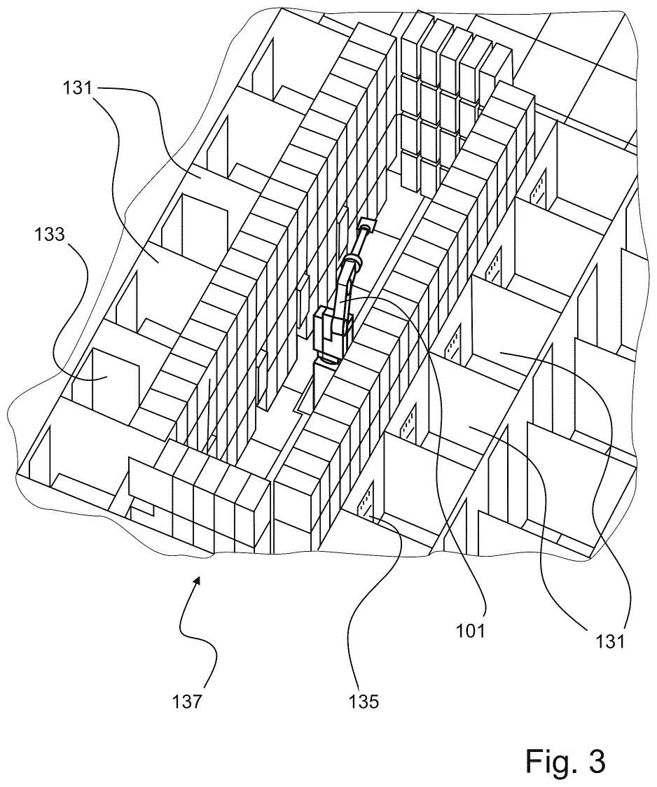

FIG. 3 shows an isometric view of a changing area according to the invention with two rows of changing cubicles, two shelf storages and a manipulator movable in the aisle between the shelf storages;

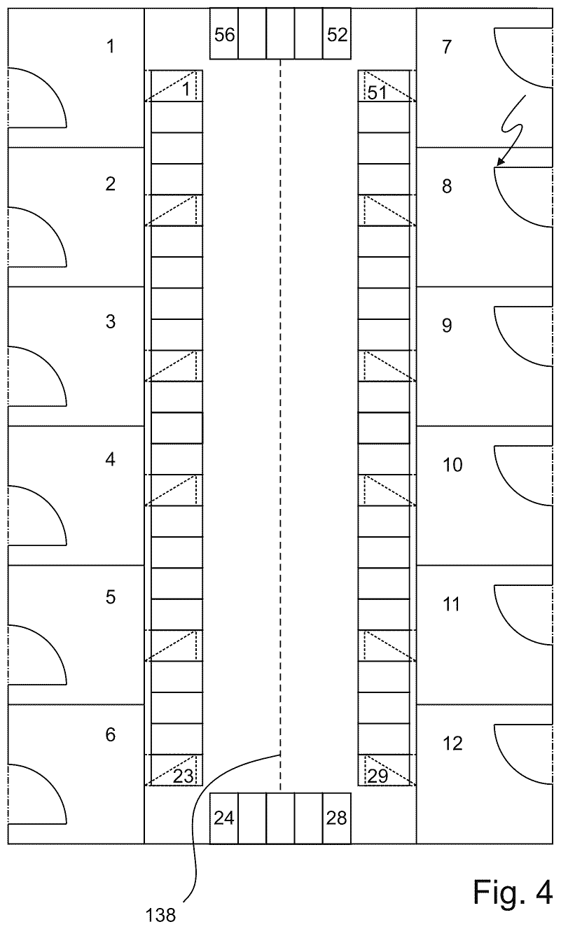

FIG. 4 shows a plan view of a changing area according to the invention (without manipulator)

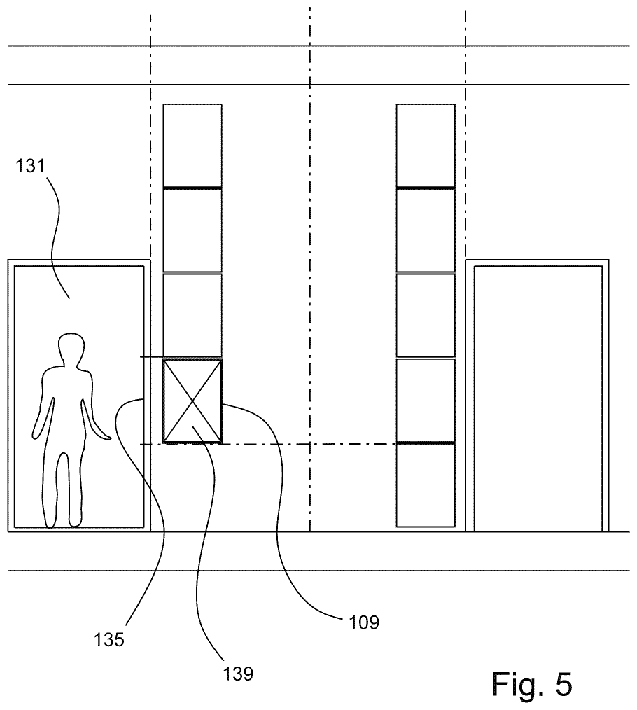

FIG. 5 shows a section through the changing area in accordance with FIG. 4; and

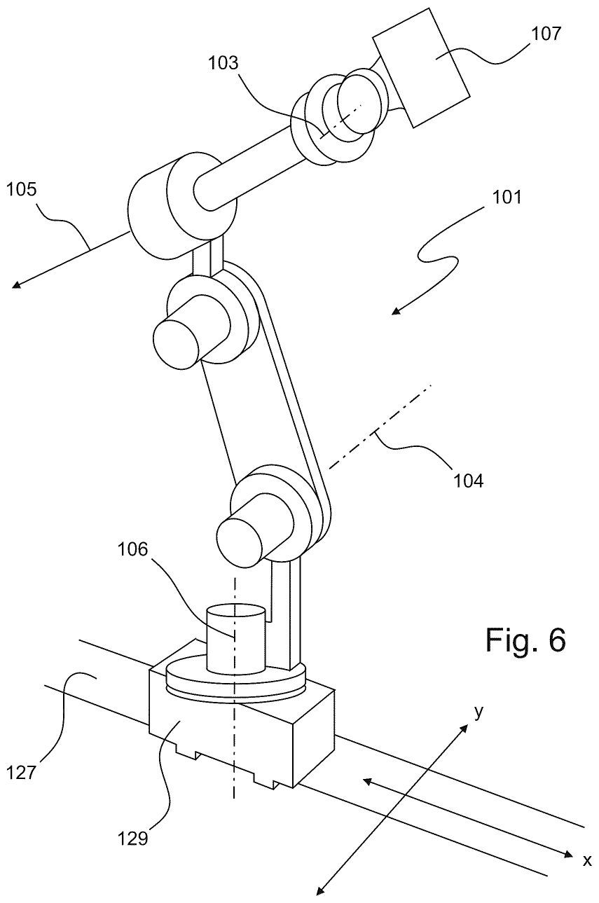

FIG. 6 shows an embodiment of a manipulator.

### DESCRIPTION OF THE EXEMPLARY EMBODIMENTS

FIG. 1 shows a wall 1 of a changing cubicle according to the invention. The side walls as well as the floor and ceiling of the changing cubicle are only partially shown and are not provided with reference signs. The wall in which there is an entrance door is not shown.

Wall 1 is the wall opposite the entrance door (not shown) of the changing cubicle. It can therefore also be referred to as the rear wall. There is an opening 131 in the wall 1. This opening 131 can be closed with a flap or a slider (not shown) and opened when necessary.

In the changing cubicle according to the invention, a shelf storage 137 is arranged behind the wall 1, i.e., outside the changing cubicle (i.e., on the outer walls of the changing cubicles 131), which is shown in FIG. 2.

FIG. 2 shows an external view (of the outer wall) of the wall 1 shown in FIG. 1. In FIG. 2, the wall 1 is largely concealed by the aforementioned shelf storage. In this exemplary embodiment, this shelf storage 137 has four levels stacked vertically one over the other and five columns arranged next to one another. The shelf storage therefore has a total of twenty storage locations LP (the number of storage locations is the product of the number of columns (m=5) and the number of rows arranged one above the other (n=4) ).

If the storage locations LP are numbered according to the running indices, then the storage location LP_{4,2} is positioned so that it is behind the opening 131 (see FIG. 1). A flap (which does not have a reference sign) arranged in front of the opening 131 in the wall 1 is shown in FIG. 2.

If there is a storage box (not shown) in storage location LP 4,2, the user of the changing cubicle can access the storage box located in storage location LP_{4,2}through opening 131. The user can fill it or remove objects from it. He can also lift it into the interior of the changing cubicle 131 and fill it there or remove items from it.

The other nineteen storage locations are not accessible to the user inside the changing cubicle because wall 1 has only one opening 131, which provides access to exactly one storage location (here LP_{4,2}) from inside the changing cubicle.

FIG. 2 also shows that the shelf storage 137 behind the wall 1 of the changing cubicle is significantly higher than the changing cubicle. The height Huk of the changing cubicle and the height HRL of shelf storage 137 are shown in FIG. 2. An optional intermediate ceiling 7 is installed above the shelf storage 137, which ensures that an optional transport level above the shelf storage 137 is spatially separated from the user area. This reduces the risk of accidents and gives the changing area a more attractive appearance.

Above the intermediate ceiling 7 is an optional transport level with a horizontal conveyor device 9, which is only shown schematically. The horizontal conveyor device 9 is used to transport storage boxes 109 between different changing areas that are arranged next to one another, only one of which is shown in FIG. 1.

FIG. 3 shows an exemplary embodiment of a changing area according to the invention in an isometric view. For reasons of clarity, only a few changing cubicles have been provided with reference signs. In the left row of changing cubicles 131 in FIG. 3, the doors 133 are shown open. On the wall opposite the doors 133, the aforementioned opening 135 is cut out. This opening can be seen in the changing cubicles 131 of the right row in FIG. 3. This opening 135 can be closed with a flap or a slider or opened when necessary.

In an aisle that is formed by the two rows of changing cubicles 131, there are two shelf storages 137 which, as shown in FIG. 2, are arranged directly on the outer walls of the changing cubicles 131.

A movable or stationary manipulator 101 is provided in the aisle between the shelf storages 137. Details of the manipulator 101 are illustrated in FIG. 6 and explained further below.

An effector 107 (see FIG. 6) of the manipulator 101 can reach all storage locations LP of the shelf storage 137.

It can pick up or grab a storage box 109 that is located in any of the storage locations and place it at any storage location.

FIG. 4 shows the changing area according to the invention in a plan view. It comprises two rows of six changing cubicles 131 each, which are numbered from 1 to 12 in FIG. 4. In this embodiment, these storage locations are located on both sides of the longitudinal axis 138 of an aisle within which the manipulator 101 moves. These storage locations are numbered 1 to 23 and 29 to 51.

In addition, additional (optional) storage locations can be available at the ends of the aisle. In FIG. 8, they have the numbers 24 to 28 and 52 to 56.

The manipulator 101 can reach the storage locations of all shelf storages 137 and remove storage boxes 109 therefrom or store them therein.

In this exemplary embodiment, the shelf storage 137 comprises fifty-six storage locations on one level. As a rule, the shelf storage 137 comprise a plurality of levels (e.g., 4 or 5 levels) in which storage locations LP are present.

The number of storage locations available on one level can be adapted to requirements by adjusting the length and width of the aisle.

In the embodiment shown in FIG. 5, storage locations are arranged on five levels one above the other. In total, there are more than two hundred and fifty storage locations for storage boxes 109 available in the changing area.

The manipulator 101 is located inside the changing area and between the shelf storages 137 (see FIG. 6). It can be moved in the direction of an X-axis and optionally additionally in the direction of a Y-axis. In FIGS. 4 and 5, the manipulator 101 is not shown.

As already mentioned, the manipulator 101 can reach any storage location of the shelf storage 137. With the help of the effector 107, it can remove a storage box that is placed in one of the storage locations and place it in another storage location.

The operation of the changing area according to the invention is explained below with reference to FIG. 5.

If a storage box 109 is placed by the manipulator 101 at the storage location 139 located directly behind the opening 135 in the changing cubicle 131, then the user of the changing cubicle 131 can place his clothes and personal belongings in this storage box 109 at the beginning of his visit after he has changed.

As soon as the user wants to leave the changing cubicle, he can give a signal that this storage box 109 can be removed. This signal can also be generated automatically when the user leaves the changing cubicle 131.

Then, the manipulator 101 with its effector 107 approaches storage box 109 i, storage location 139, and takes this storage box 109 out of the storage location 139. It then places this storage box 139 in another storage location in the changing area. It only places the storage box 109 in a storage location that is not located directly behind an opening 135 of a changing cubicle 131. This storage box 109 is thus protected from access by unauthorized persons.

As soon as the storage location 139 is “empty” again, the next user can enter the changing cubicle 131. When this user has just entered the spa, an empty storage box 109 is placed in the storage location 139 for him behind the opening 135 in the changing cubicle 131. He can then change his clothes.

When the next user wants to end his visit to the spa, he has the storage box 109 filled with his items, which is located at any storage location of the shelf storage 137, brought to the storage location 139, which is located directly behind the opening 135 in his changing cubicle 131.

The user can then open the storage box 109 and remove his belongings and clothing so that he can get dressed again.

The same procedures are carried out in the other changing cubicles 131. This makes it possible for a plurality of hundred users to “share” twelve changing cubicles, with users naturally using the changing cubicles one after the other.

The aisle in which the manipulator 101 moves is not accessible to the public; no one is present there during operation so that the manipulator 101 poses no danger to the public or employees.

FIG. 6 shows an embodiment of a manipulator 101 according to the invention with an effector 107 shown only schematically. The manipulator 101 has four rotation axes 103, 105, 104 and 106. In addition, the manipulator 101 can be linearly movable in the direction of the X-axis.

Additionally, a Y-axis (optional) may be present. It can be advantageous if the alley is very wide. By controlling the optional Y-axis, the manipulator 101 can reach the shelf storage on both sides of the aisles, even in very wide aisles.

Only indicated is a rail 127 on which a base part 129 of the manipulator 101 can be moved in the direction of the X-axis. By controlling the rotary axes 103 to 106 and the linear axis/axes) in the direction of the X and Y axes, the effector 107 can assume a plurality of positions and orientations within its working range. It can be moved with a holding surface of the effector 107 to the counterpart/a counter surface of a storage box 109 (not shown).

Subsequently, the holding elements of the effector 107 are activated, and the connection between the effector 107 and the storage box 109 is established so that the storage box can be brought to the desired location and placed there with the aid of the manipulator 101. The connection between effector 107 and storage box 109 is then released.

The structure and function of the effector 107 and its interaction with a storage box 109 are described in a patent application “Storage Box Manipulator” filed with the DPMA on the same day by the same applicant, the disclosure of which is hereby incorporated by way of reference into this patent application.

### LIST OF REFERENCE SIGNS

1 Wall of a changing cubicle
LP Storage location
HUK Height
HLR Height of the shelf storage
7 Intermediate ceiling
9 Horizontal conveyor device
101 Storage box manipulator
103 to 106 Rotary axes of the manipulator
107 Effector
109 Storage box
127 Rail
129 Base part
131 Changing cubicle
133 Changing cubicle door
135 Opening
137 Shelf storage
138 Longitudinal axis
139 Storage location

1-12. (canceled)

13. A changing area comprising a plurality of changing cubicles, each changing cubicle including a plurality of walls and a door, wherein a wall of each changing cubicle has an opening that exposes a storage location for a storage box, wherein the plurality of changing cubicles are arranged in a row next to one another, wherein a shelf storage for storing storage boxes is arranged behind the walls with openings of the changing cubicles, wherein a plurality of storage locations for storing storage boxes are arranged side by side and one above the other in the shelf storage, wherein the shelf storage is arranged directly behind the walls with openings of the changing cubicles, wherein the storage locations assigned to the changing cubicles are integrated into the shelf storage, wherein a manipulator with an effector is positioned behind the shelf storage, and wherein all storage locations of the shelf storage, including the storage locations assigned to the changing cubicles, are accessible by the effector of the manipulator, the manipulator being an articulated arm robot.

14. The changing area of claim 13, wherein two rows of changing cubicles are arranged at a distance from one another, and wherein one shelf storage per row and one manipulator are provided in an aisle formed by the two rows of changing cubicles.

15. The changing area of claim 14, wherein additional rows of changing cubicles are arranged at one or both ends of the aisle.

16. The changing area of claim 13, wherein the manipulator is movable along the shelf storage and in the aisle between two shelf storages.

17. The changing area of claim 16, wherein the manipulator is mounted on an automatic transport vehicle, and wherein the transport vehicle follows a continuous or an interrupted guide line by sensors.

18. The changing area of claim 17, wherein the guide line is optical, magnetic, or inductive, and wherein the guide line is detected with cameras, Hall sensors, or antennas.

19. The changing area of claim 17, wherein rails or a linear guide are used as the guide line.

20. The changing area of claim 13, wherein a horizontal conveyor device is arranged above the manipulator, and wherein the horizontal conveyor device is configured to accept a storage box from a first manipulator and deliver the storage box to a second manipulator of another changing area.

21. The changing area of claim 13, wherein a plurality of changing areas are arranged one above the other on two or more levels, and wherein at least one vertical conveyor device interconnects the changing areas of different levels such that storage boxes are transportable between different levels.

22. The changing area of claim 13, wherein the rows of changing cubicles are straight or curved.

23. The changing area of claim 13, wherein the manipulator comprises an effector, and wherein the effector is detachably connectable to an interface of a storage box.
